(19) United States
(12) Patent Application Publication
(10) Pub. No.: US 2023/0419751 A1
(43) Pub. Date: Dec. 28, 2023

(54) VEHICLE DISPLAY DEVICE, VEHICLE DISPLAY SYSTEM, AND VEHICLE DISPLAY METHOD

(71) Applicant: TOYOTA JIDOSHA KABUSHIKI KAISHA, Aichi-ken (JP)

(72) Inventors: Kota WASHIO, Shizuoka-ken (JP); Ryosuke TOSAKA, Toyota-shi (JP); Hitoshi KUMON, Aichi-ken (JP); Yuichi KUBOTA, Toyota-shi (JP); Toko TAGA, Toyota-shi (JP)

(21) Appl. No.: 18/304,351

(22) Filed: Apr. 21, 2023

(30) Foreign Application Priority Data
Jun. 28, 2022 (JP) 2022-103856

(51) Int. Cl. G07C 5/08; B60K 35/00

(52) U.S. Cl. CPC G07C 5/0825; G07C 5/0808; B60K 35/00; B60K 2370/349

(57) ABSTRACT

A vehicle display device includes: a mode setting unit provided in a vehicle for setting a mode of the vehicle to one of a first mode and a second mode; an acquisition unit provided in the vehicle for acquiring a driving diagnosis result of the vehicle; and a display unit that can display an image representing the driving diagnosis result in a first manner when the vehicle is in the first mode, and that can display the image representing the driving diagnosis result in a second manner that is more difficult for an occupant of the vehicle to recognize than in the first manner when the vehicle is in the second mode.

### CROSS-REFERENCE TO RELATED APPLICATION

This application claims priority to Japanese Patent Application No. 2022-103856 filed on Jun. 28, 2022, incorporated herein by reference in its entirety.

### BACKGROUND

### 1. Technical Field

The present disclosure relates to a vehicle display device, a vehicle display system, and a vehicle display method.

### 2. Description of Related Art

Japanese Unexamined Patent Application Publication No. 2009-196529 (JP 2009-196529 A) discloses an auditory information provision device capable of presenting predetermined auditory information only to a specific occupant.

### SUMMARY

JP 2009-196529 A has room for improvement in displaying information related to driving diagnosis so that another occupant different from the specific occupant does not know the content of the information.

In consideration of the above fact, an object of the present disclosure is to provide a vehicle display device, a vehicle display system, a vehicle display method, and a storage medium capable of displaying information related to driving diagnosis in such a manner that the information is not known to another occupant different from a specific occupant.

A vehicle display device according to claim 1 includes: a mode setting unit provided in a vehicle for setting a mode of the vehicle to one of a first mode and a second mode; an acquisition unit provided in the vehicle for acquiring a driving diagnosis result of the vehicle; and a display unit that is able to display an image representing the driving diagnosis result in a first manner when the vehicle is in the first mode, and that is able to display the image representing the driving diagnosis result in a second manner that is more difficult for an occupant of the vehicle to recognize than in the first manner when the vehicle is in the second mode.

In the claims and the specification, “the occupant recognizes the image representing the driving diagnosis result” includes both meanings that the occupant understands the meaning of the image representing the driving diagnosis result and that the occupant visually recognizes the image representing the driving diagnosis result. Further, in the claims and the specification, “it is more difficult for the occupant to recognize the image in the second manner than in the first manner” means that it is more difficult for the occupant with normal comprehension and normal visual perception to recognize the image in the second manner than in the first manner.

In the vehicle display device according to claim 1, the display unit can display the image representing the driving diagnosis result in the second manner that is more difficult for an occupant of the vehicle to recognize than in the first manner when the vehicle is in the second mode. Here, it is assumed that one of a plurality of occupants present in the vehicle is a specific occupant (hereinafter referred to as a specific occupant). In this case, it is more difficult for all occupants including the specific occupant to recognize the image in the second manner than in the first manner. However, for example, if only the specific occupant understands the meaning of the image representing the driving diagnosis result, the specific occupant will be able to know the content of the driving diagnosis result even if the image representing the driving diagnosis result is difficult to visually recognize. Therefore, the vehicle display device according to claim 1 can display information related to the driving diagnosis without another occupant different from the specific occupant knowing the content of the information.

In the vehicle display device according to the disclosure described in claim 2, in the disclosure according to claim 1, at least one of brightness and saturation of the image representing the driving diagnosis result in the second manner is lower than the at least one of the brightness and the saturation of the image representing the driving diagnosis result in the first manner.

In the disclosure according to claim 2, since at least one of the brightness and the saturation of the image representing the driving diagnosis result in the second manner is lower than that of the image representing the driving diagnosis result in the first manner, it is more difficult for the occupant to recognize the image in the second manner than in the first manner.

In the vehicle display device according to the disclosure described in claim 3, in the disclosure according to claim 1 or 2, the image representing the driving diagnosis result in the first manner includes a character, and the image representing the driving diagnosis result in the second manner does not include a character.

In the disclosure according to claim 3, the image representing the driving diagnosis result in the first manner includes a character, and the image representing the driving diagnosis result in the second manner does not include a character. Therefore, it is more difficult for the occupant to recognize the image in the second manner than in the first manner.

The vehicle display device according to the disclosure described in claim 4 includes, in the disclosure according to claim 1 or 2, a classification unit that classifies the driving diagnosis result into a first diagnosis result or a second diagnosis result based on content of the driving diagnosis result. The display unit displays the image representing the second diagnosis result in the second manner when the vehicle is in the second mode and the acquisition unit acquires the second diagnosis result.

According to the disclosure described in claim 4, the display unit displays the image representing the second diagnosis result in the second manner when the vehicle is in the second mode and the acquisition unit acquires the second diagnosis result. Therefore, for example, when it is not preferable for the second diagnosis result to be known to the occupant other than the specific occupant, the second diagnosis result can be suppressed from being known to the occupant other than the specific occupant.

In the vehicle display device according to the disclosure described in claim in the disclosure according to claim 1 or 2, the display unit is provided on an instrument panel provided in front of a driver's seat of the vehicle.

According to the disclosure described in claim 5, the distance from the occupant seated behind the driver's seat to the display unit is longer than the distance from the driver seated in the driver's seat to the display unit. This makes it more difficult for this occupant to recognize the second diagnosis result displayed on the display unit. Therefore, for example, when it is not preferable for the second diagnosis result to be known to this occupant, the second diagnosis result can be suppressed from being known to this occupant.

The vehicle display device according to the disclosure described in claim 6 includes, in the disclosure according to claim 1 or 2, an occupant determination unit provided in the vehicle for determining whether there is a general occupant other than a driver in the vehicle based on information from a sensor provided in the vehicle. The mode setting unit sets the vehicle to the second mode when the occupant determination unit determines that there is the general occupant.

According to the disclosure described in claim 6, the occupant determination unit determines whether there is a general occupant other than the driver in the vehicle based on information from a sensor provided in the vehicle. The mode setting unit sets the vehicle to the second mode when the occupant determination unit determines that there is the general occupant. Therefore, for example, when it is not preferable for the second diagnosis result to be known to the general occupant, the second diagnosis result can be suppressed from being known to the general occupant.

A vehicle display system according to the disclosure described in claim 7 includes: the vehicle display device according to claim 1 or claim 2; and a driving diagnosis unit that executes driving diagnosis of the vehicle and generates the driving diagnosis result.

A vehicle display method according to the disclosure described in claim 8 includes: a step of setting a mode of a vehicle to one of a first mode and a second mode; a step of acquiring a driving diagnosis result of the vehicle; and a step of causing a display unit to be able to display an image representing the driving diagnosis result in a first manner when the vehicle is in the first mode, and causing the display unit to be able to display the image representing the driving diagnosis result in a second manner that is more difficult for an occupant of the vehicle to recognize than in the first manner when the vehicle is in the second mode.

In a storage medium according to the disclosure described in claim 9, a program causes a computer to execute: a process of setting a mode of a vehicle to one of a first mode and a second mode; a process of acquiring a driving diagnosis result of the vehicle; and a process of causing a display unit to be able to display an image representing the driving diagnosis result in a first manner when the vehicle is in the first mode, and causing the display unit to be able to display the image representing the driving diagnosis result in a second manner that is more difficult for an occupant of the vehicle to recognize than in the first manner when the vehicle is in the second mode.

As described above, the vehicle display device, the vehicle display system, the vehicle display method, and the storage medium according to the present disclosure has the excellent effect of being able to display information related to driving diagnosis in such a manner that the information is not known to another occupant different from a specific occupant.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is an overall view of a vehicle display system according to a first embodiment;

FIG. 2 is a schematic plan view of a vehicle shown in FIG. 1, omitting a roof portion;

FIG. 3 is a control block diagram of an electronic control unit (ECU) of the vehicle and an external server shown in FIG. 1;

FIG. 4 is a functional block diagram of the ECU;

FIG. 5 is a functional block diagram of the external server;

FIG. 6 is a diagram showing a display displaying a positive driving diagnosis result related to an accelerator pedal operation in a first manner;

FIG. 7 is a diagram showing a display displaying a positive driving diagnosis result related to an accelerator pedal operation in a second manner;

FIG. 8 is a diagram showing a display displaying a negative driving diagnosis result related to an accelerator pedal operation in a first manner;

FIG. 9 is a diagram showing a display displaying a negative driving diagnosis result related to an accelerator pedal operation in a second manner;

FIG. 10 is a front view showing an instrument panel and a fare meter device;

FIG. 11 is a front view showing the instrument panel and a mode changeover switch;

FIG. 12 is a flowchart showing a process executed by the external server;

FIG. 13 is a flowchart showing a process executed by a central processing unit (CPU) of the ECU;

FIG. 14 is a flowchart showing a process executed by the CPU;

FIG. 15 is a functional block diagram of an ECU of a second embodiment;

FIG. 16 is a diagram showing a classification list recorded in the ECU of the second embodiment; and

FIG. 17 is a flowchart showing a process executed by a CPU of the second embodiment.

### DETAILED DESCRIPTION OF EMBODIMENTS

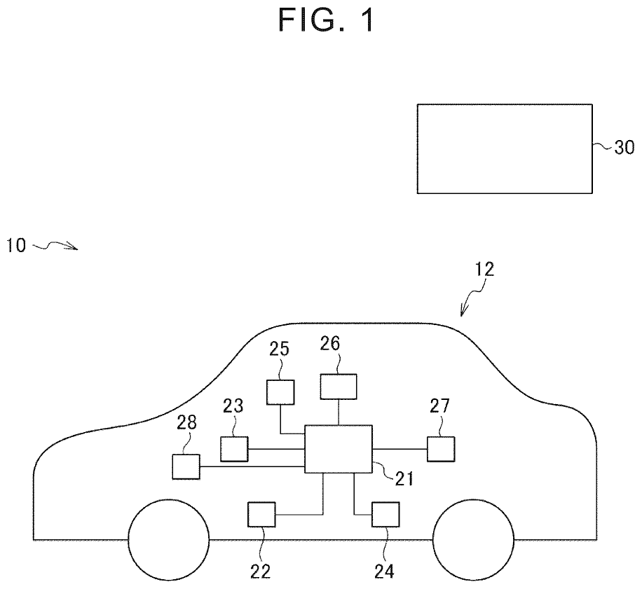

A first embodiment of a vehicle display device, a vehicle display system (hereinafter referred to as a system), a vehicle display method, and a program according to the present disclosure will be described below with reference to FIGS. 1 to 14.

A system 10 of the first embodiment includes a vehicle 12 and an external server 30 as shown in FIG. 1. The external server 30 of the first embodiment is owned by a taxi operation company, and the taxi operation company owns a large number of vehicles 12 used as taxis. Each vehicle 12 is assigned an ID.

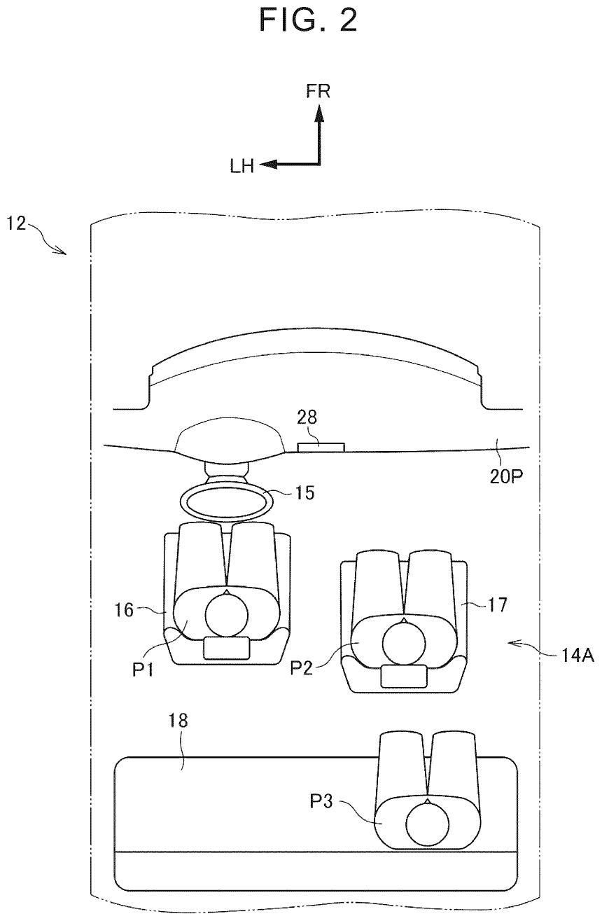

As shown in FIG. 2, a pair of right and left front seats 16, 17 are provided in a vehicle cabin 14A of the vehicle 12 capable of data communication with the external server 30 via a network. Note that the arrow FR shown in FIG. 2 indicates the front side in the vehicle front-rear direction, and the arrow LH indicates the left side in the vehicle right-left direction (vehicle width direction). The front seats 16, 17 are seats in the frontmost row. A steering wheel 15 is provided on the left portion of an instrument panel 20P provided at the front end of the vehicle cabin 14A. That is, the left front seat 16 is the driver's seat, and the right front seat 17 is the passenger's seat. Furthermore, a rear seat 18 positioned behind the front seats 16, 17 is provided in the vehicle cabin 14A. An occupant P1 is seated in the front seat 16, an occupant (general passenger) P2 is seated in the front seat 17, and an occupant (general passenger) P3 is seated in the rear seat 18. The occupant P1 is referred to as a driver P1 in the following description.

The vehicle 12 includes an electronic control unit (ECU) 21, a wheel speed sensor 22, an accelerator operation amount sensor 23, a brake depression force sensor 24, a steering angle sensor 25, an in-vehicle camera (sensor) 26, a global positioning system (GPS) receiver 27, and a display 28 as shown in FIG. 1. The wheel speed sensor 22, the accelerator operation amount sensor 23, the brake depression force sensor 24, the steering angle sensor 25, the in-vehicle camera 26, the GPS receiver 27, and the display (display unit) 28 are connected to the ECU 21. In the following description, the wheel speed sensor 22, the accelerator operation amount sensor 23, the brake depression force sensor 24, the steering angle sensor 25, the in-vehicle camera 26, and the GPS receiver 27 may be collectively referred to as “information acquisition unit”.

The vehicle 12 is provided with the four wheel speed sensors 22. Each wheel speed sensor 22 detects a wheel speed of corresponding one of the four wheels. The accelerator operation amount sensor 23 detects the accelerator operation amount that changes in conjunction with the operation of the accelerator pedal by the driver P1 sitting in the driver's seat of the vehicle 12. The brake depression force sensor 24 detects a brake pedal force input by the driver P1 to a brake pedal (not shown). The steering angle sensor 25 detects the steering angle of the steering wheel 15 operated by the driver P1. The in-vehicle camera 26 acquires image data of a subject located inside the vehicle 12. This subject includes, for example, the driver P1 and the occupants P2, P3. The GPS receiver 27 acquires information on a position where the vehicle 12 is traveling (hereinafter, referred to as “position data”) by receiving a GPS signal transmitted from a GPS satellite. Acquired data acquired by the information acquisition unit every time a predetermined time elapses is transmitted to the ECU 21 via an in-vehicle network provided in the vehicle 12, and stored in a storage 21D of the ECU 21, which will be described later, in association with time information. This in-vehicle network is, for example, a controller area network (CAN). In the following description, the acquired data acquired by the information acquisition unit may be referred to as “vehicle-related information”.

As shown in FIG. 2, the display 28 having a touch panel provided in the center of the instrument panel 20P of the vehicle 12 in the right-left direction can display various images. The display 28 is positioned in front of the front seats 16, 17.

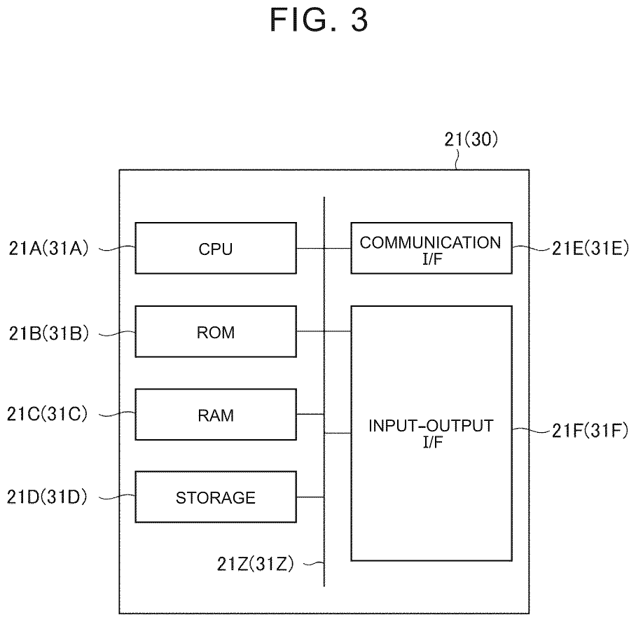

The ECU (computer) 21 is configured to include a central processing unit (CPU: processor) 21A, a read-only memory (ROM) 21B, a random access memory (RAM) 21C, a storage 21D, a communication interface (I/F) 21E, and an input-output I/F 21F as shown in FIG. 3. The CPU 21A, the ROM 21B, the RAM 21C, the storage 21D, the communication I/F 21E, and the input-output I/F 21F are connected so as to be able to communicate with each other via a bus 21Z. The CPU 21A can acquire information related to the date and time from a timer (not shown).

The CPU 21A is a central processing unit that executes various programs and controls various units. That is, the CPU 21A reads a program from the ROM 21B or the storage 21D and executes the program using the RAM 21C as a work area. The CPU 21A controls each configuration and executes various arithmetic processes (information processes) in accordance with the program recorded in the ROM 21B or the storage 21D. The ROM 21B or the storage 21D is an example of a storage medium.

The ROM 21B stores various programs and various data. The RAM 21C temporarily stores programs or data as a work area. The storage 21D is composed of a storage device such as a hard disk drive (HDD) or a solid state drive (SSD), and stores various programs and various data.

The communication I/F 21E is an interface for communicating with various devices. For example, the communication I/F 21E can communicate with a device other than the ECU 21 provided in the vehicle 12 via the in-vehicle network. These devices include, for example, the information acquisition unit. Further, the communication I/F 21E can wirelessly communicate with the external server 30 via a network (for example, the Internet).

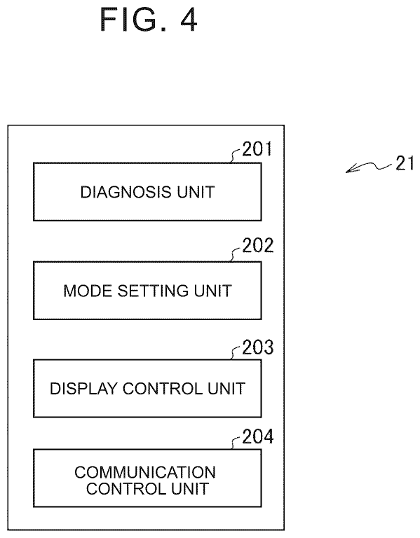

An example of the functional configuration of the ECU 21 is shown in FIG. 4 as a block diagram. The ECU 21 has a diagnosis unit (driving diagnosis unit) (acquisition unit) 201, a mode setting unit 202, a display control unit 203, and a communication control unit 204 as functional configurations. These functional configurations are realized as the CPU 21A reads and executes the program stored in the ROM 21B.

The diagnosis unit 201 performs driving diagnosis based on the acquired data of the wheel speed sensor 22, the accelerator operation amount sensor 23, the brake depression force sensor 24, and the steering angle sensor 25. For example, as disclosed in Japanese Unexamined Patent Application Publication No. 2019-12481 (JP 2019-12481 A) and Japanese Unexamined Patent Application Publication No. 2020-95403 (JP 2020-95403 A), a driving diagnosis method that is performed based on the above acquired data is well known.

The diagnosis unit 201 performs driving diagnosis on the operation of the accelerator pedal of the vehicle 12 based on the acquired data of the accelerator operation amount sensor 23 and the acquired data of the wheel speed sensor 22. Further, the diagnosis unit 201 performs driving diagnosis on the operation of the brake pedal of the vehicle 12 based on the acquired data of the brake depression force sensor 24 and the acquired data of the wheel speed sensor 22. Furthermore, the diagnosis unit 201 performs driving diagnosis on the steering operation based on the acquired data of the steering angle sensor 25.

The information on the result of the driving diagnosis based on the acquired data of the wheel speed sensor 22, the accelerator operation amount sensor 23, the brake depression force sensor 24, and the steering angle sensor 25 is the information on the results of the real-time driving diagnosis. These result information are recorded in the storage 21D together with the position data and the time information. In the following description, the results of the real-time driving diagnosis are referred to as “driving diagnosis result”.

The mode setting unit 202 switches modes of the vehicle 12 based on the mode setting information recorded in the storage 21D. This mode includes a first mode and a second mode.

The display control unit 203 controls the display 28. The display 28

controlled by the display control unit 203 can display information about the driving diagnosis result for a predetermined display time. This display time is, for example, 5 seconds.

Note that the display control unit 203 changes the control method of the display 28 depending on whether the vehicle 12 is in the first mode or the second mode.

When the vehicle 12 is in the first mode, the display control unit 203 causes the display 28 to display the driving diagnosis result in the first manner. On the other hand, when the vehicle 12 is in the second mode, the display control unit 203 causes the display 28 to display the driving diagnosis result in the second manner. The second manner is a display manner that is more difficult for the driver P1 and the occupants P2, P3 to recognize than in the first manner. Here, “the driver P1 and the occupants P2, P3 recognize the driving diagnosis result displayed on the display 28” includes both meanings that the driver P1 and the occupants P2, P3 understand the meaning of the image representing the driving diagnosis result and that the driver P1 and the occupants P2, P3 visually recognize the image representing the driving diagnosis result. The driver P1 and the occupants P2, P3 are assumed to have normal comprehension and normal visual perception. Therefore, it may be more difficult for the driver P1 and the occupants P2, P3 to understand the meaning of the driving diagnosis result displayed in the second manner than the driving diagnosis result displayed in the first manner. Further, it may be more difficult for the driver P1 and the occupants P2, P3 to visually recognize the driving diagnosis result displayed in the second manner than the driving diagnosis result displayed in the first manner. Furthermore, it may be more difficult for the driver P1 and the occupants P2, P3 to understand the meaning of the driving diagnosis result and visually recognize the driving diagnosis result displayed in the second manner than the driving diagnosis result displayed in the first manner.

However, the driver P1 understands the meaning of all the images of the driving diagnosis result displayed in the second manner. On the other hand, it is assumed that the occupants P2, P3 do not understand the meaning of all the images of the driving diagnosis result displayed in the second manner.

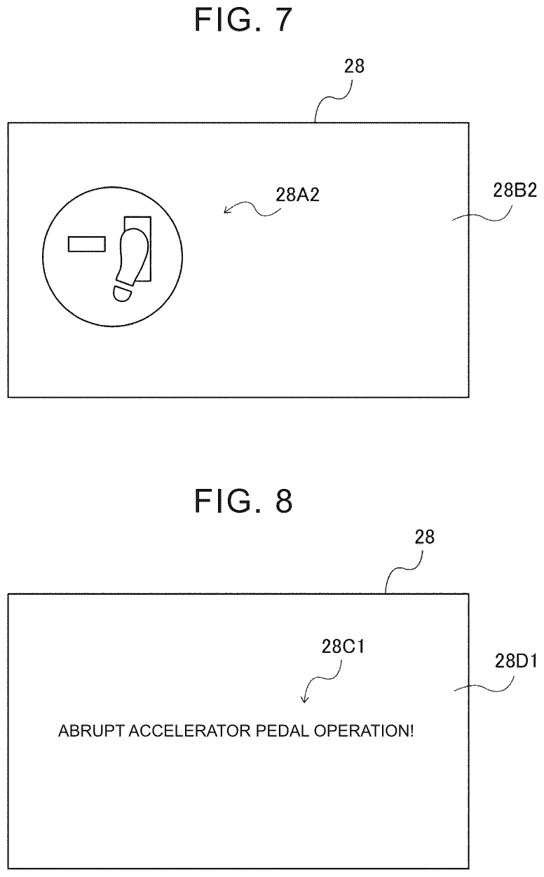

For example, the display 28 in FIGS. 6 and 7 both display a positive driving diagnosis result related to accelerator pedal operation. The display manner of the driving diagnosis result in FIG. 6 is the first manner, and the display manner of the driving diagnosis result in FIG. 7 is the second manner.

The image 28A1 representing the driving diagnosis result in the first manner shown in FIG. 6 is drawn with characters representing the content of the driving diagnosis result. On the other hand, the image 28A2 representing the driving diagnosis result in the second manner shown in FIG. 7 is a figure that does not directly represent the content of the driving diagnosis result. Therefore, it is more difficult for the driver P1 and the occupants P2, P3 to understand the meaning represented by the image 28A2 than the meaning represented by the image 28A1.

The brightness and saturation of the image 28A2 are lower than the brightness and saturation of the image 28A1. Further, the contrast between the image 28A2 and the image 28B2 of the portion other than the image 28A2 on the display 28 in FIG. 7 is smaller than the contrast between the image 28A1 and the image 28B1 of the portion other than the image 28A1 on the display 28 in FIG. 6. Therefore, it is more difficult for the driver P1 and the occupants P2, P3 to visually recognize the image 28A2 than the image 28A1.

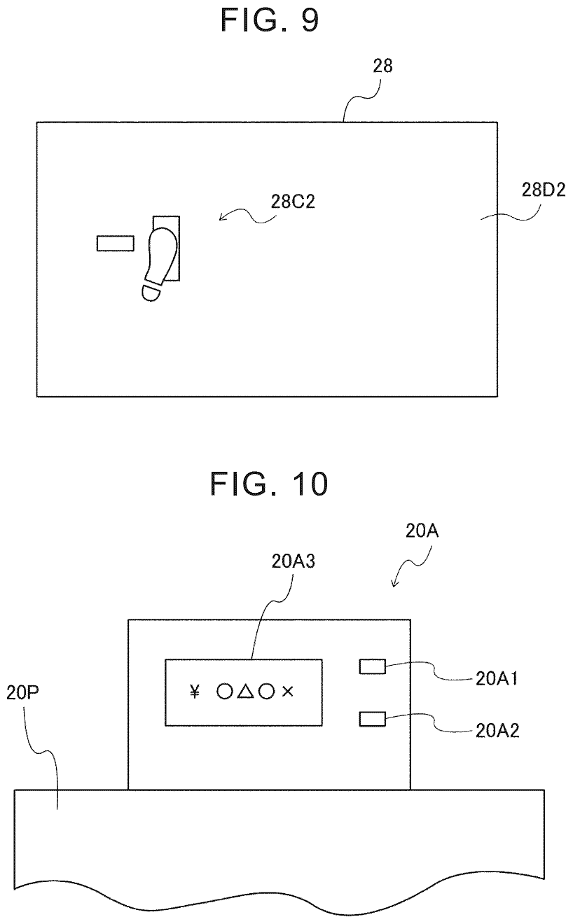

For example, the display 28 in FIGS. 8 and 9 both display a negative driving diagnosis result related to accelerator pedal operation. The display manner of the driving diagnosis result in FIG. 8 is the first manner, and the display manner of the driving diagnosis result in FIG. 9 is the second manner.

The image 28C1 representing the driving diagnosis result in the first manner shown in FIG. 8 is drawn with characters representing the content of the driving diagnosis result. On the other hand, the image 28C2 representing the driving diagnosis result in the second manner shown in FIG. 9 is a figure that does not directly represent the content of the driving diagnosis result. Therefore, it is more difficult for the driver P1 and the occupants P2, P3 to understand the meaning represented by the image 28C2 than the meaning represented by the image 28C1.

The brightness and saturation of the image 28C2 are lower than the brightness and saturation of the image 28C1. Further, the contrast between the image 28C2 and the image 28D2 of the portion other than the image 28C2 on the display 28 in FIG. 9 is smaller than the contrast between the image 28C1 and the image 28D1 of the portion other than the image 28C1 on the display 28 in FIG. 8. Therefore, it is more difficult for the driver P1 and the occupants P2, P3 to visually recognize the image 28C2 than the image 28C1.

The communication control unit 204 controls the communication I/F 21E. The communication I/F 21E controlled by the communication control unit 204 is capable of wireless communication with the external server 30. For example, the communication I/F 21E can receive the mode setting information, which will be described later, transmitted from the external server 30. The communication I/F 21E that has received the mode setting information records the mode setting information in the storage 21D.

As shown in FIG. 3, the external server 30 is configured to include a CPU 31A, a ROM 31B, a RAM 31C, a storage 31D, a communication I/F 31E, and an input-output I/F 31F. The CPU 31A, the ROM 31B, the RAM 31C, the storage 31D, the communication I/F 31E, and the input-output I/F 31F are connected so as to be able to communicate with each other via a bus 31Z. The CPU 31A, the ROM 31B, the RAM 31C, the storage 31D, the communication I/F 31E, and the input-output I/F 31F have functions corresponding to the CPU 21A, the ROM 21B, the RAM 21C, the storage 21D, the communication I/F 21E, and the input-output I/F 21F, respectively.

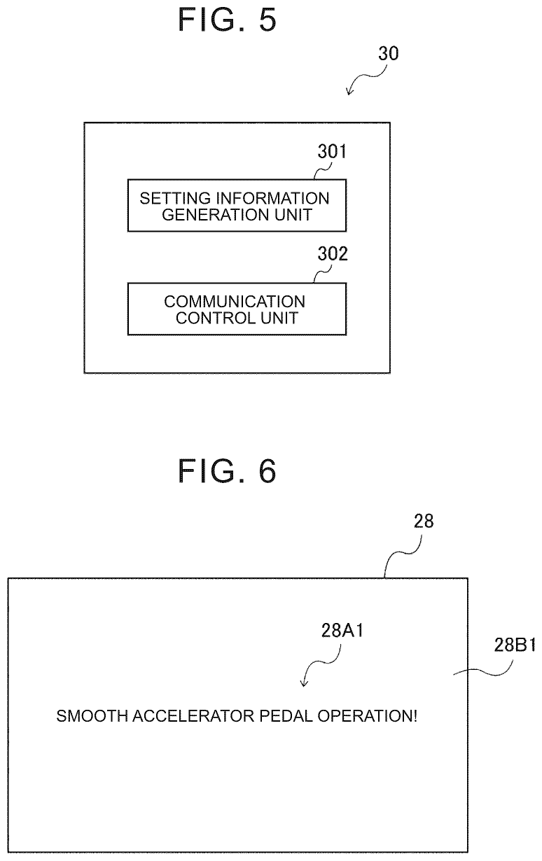

FIG. 5 is a block diagram showing an example of a functional configuration of the external server 30. The external server 30 has a setting information generation unit 301 and a communication control unit 302 as functional configurations. These functional configurations are realized as the CPU 31A reads and executes the program stored in the ROM 31B.

The setting information generation unit 301 generates the mode setting information for each vehicle 12, which is used by the mode setting unit 202 of the vehicle 12 to set the mode of the vehicle 12. That is, the mode setting information represents rules for determining the mode of the vehicle 12, and the mode setting information generated by the setting information generation unit 301 includes ID information representing the ID of each vehicle 12. The mode setting information generated by the setting information generation unit 301 is recorded in the storage 31D. When the setting information generation unit 301 updates the mode setting information, the setting information generation unit 301 updates the mode setting information recorded in the storage 31D with new information.

The external server 30 has an information input device (not shown). An administrator (not shown) of the external server 30 can use this information input device to input information representing rules for determining the mode of the vehicle 12. When the information is input using the information input device, the setting information generation unit 301 generates the mode setting information representing the input information.

The administrator can generate various mode setting information using the information input device. Examples 1 to 3 below are specific examples of the mode setting information.

Example 1: When the CPU (occupant determination unit) 21A of the ECU 21 determines that only the driver P1 is present in the vehicle 12 based on the image data acquired by the in-vehicle camera 26, the mode setting unit 202 sets the vehicle 12 to the first mode. On the other hand, when the ECU 21 determines that there is an occupant other than the driver P1 in the vehicle, the mode setting unit 202 sets the vehicle 12 to the second mode.

The image acquired by the in-vehicle camera 26 is transmitted to the ECU 21. The ROM 21B of the ECU 21 stores determination data, which is image data of the face of the driver P1, and when the image data acquired by the in-vehicle camera 26 matches the determination data, the ECU 21 determines that the driver P1 is on board. When the image data acquired from the in-vehicle camera 26 includes human image data that does not match the determination data, the ECU 21 determines that a passenger other than the driver P1 is on board.

Example 2: When the fare meter device 20A (see FIG. 10) provided on the instrument panel 20P is not calculating the fare, the mode setting unit 202 sets the vehicle 12 to the first mode. On the other hand, when the fare meter device 20A is calculating the fare, the mode setting unit 202 sets the vehicle 12 to the second mode.

When the start switch 20A1 provided in the fare meter device 20A is pushed, the fare meter device 20A starts calculating the fare. That is, a number representing the fare is displayed on the fare display 20A3. The fare calculation ends when the end switch 20A2 is pushed. The fare meter device 20A is connected to the ECU 21, and the CPU 21A recognizes that the start switch 20A1 and the end switch 20A2 have been pressed. Usually, the driver P1 causes the fare meter device 20A to calculate the fare when the occupants P2, P3 get on the vehicle 12, and pushes the end switch 20A2 when the occupants P2, P3 get off.

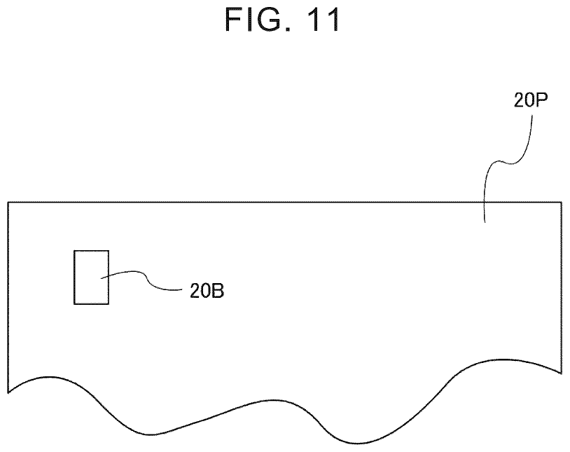

Example 3: Every time the mode changeover switch 20B (see FIG. 11) provided on the instrument panel 20P is pressed, the mode setting unit 202 switches the mode of the vehicle 12 between the first mode and the second mode.

The mode changeover switch 20B is connected to the ECU 21, and the CPU 21A recognizes that the mode changeover switch 20B has been pressed.

The communication control unit 302 controls the communication I/F 31E. The communication I/F 31E wirelessly transmits the mode setting information recorded in storage 31D to the communication I/F 21E of the vehicle 12 indicated by the ID information included in the mode setting information.

### Operation and Effects

Next, the operation and effects of the first embodiment will be described.

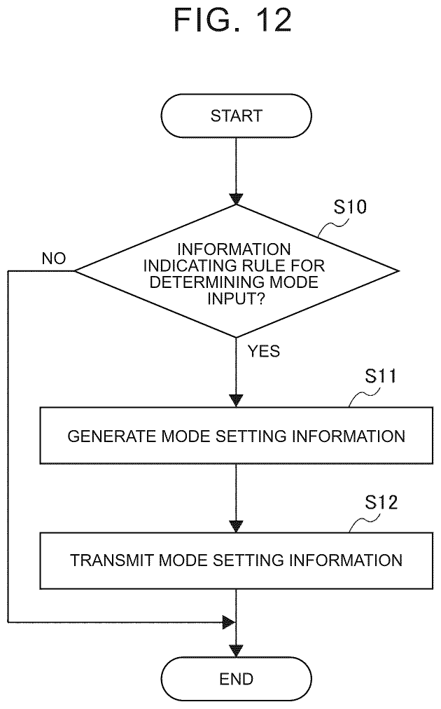

First, the flow of the process executed by the CPU 31A of the external server will be described with reference to the flowchart shown in FIG. 12. The CPU 31A repeatedly executes the process of the flowchart shown in FIG. 12 every time a predetermined time elapses. In the following description, the process of the flowchart shown in each of FIGS. 12, and 13, 14, and 17 described later is executed by one processor (CPU), but the process of the flowchart shown in each of FIGS. 12 to 14 and 17 may be executed by a plurality of processors (CPUs).

First, in S10 (hereinafter, the word “step” is omitted), the CPU 31A

determines whether information indicating the mode of the vehicle 12 has been input using the information input device.

When the determination result is Yes in S10, the CPU 31A proceeds to S11 and generates the mode setting information represented by the information input using the information input device.

Subsequently, the CPU 31A proceeds to S12 and controls the communication I/F 31E so as to wirelessly transmit the generated mode setting information to the vehicle 12.

When the determination result is No in S10 or when the process of S12 is ended, the CPU 31A temporarily ends the process of the flowchart shown in FIG. 12.

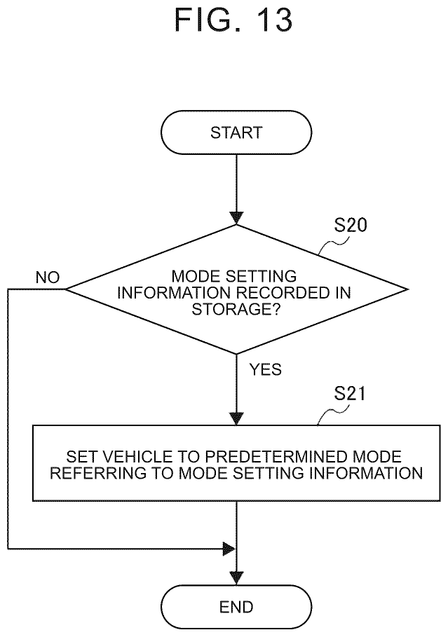

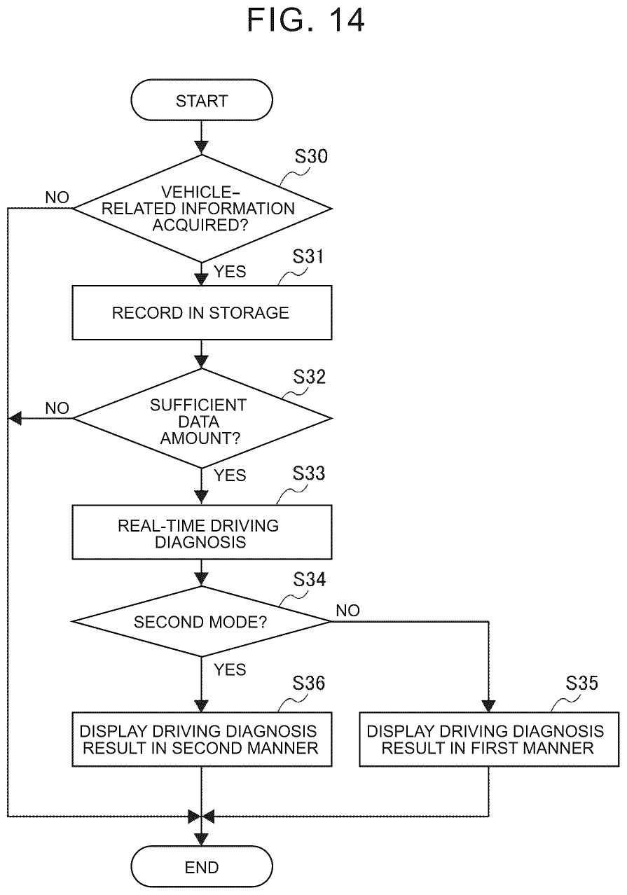

Next, the flow of the process performed by the CPU 21A of the vehicle 12 will be described. The CPU 21A repeatedly executes the process of the flowchart shown in FIGS. 13 and 14 every time a predetermined time elapses. First, the description will be made with reference to the flowchart of FIG. 13.

In S20, the CPU 21A determines whether the mode setting information is recorded in the storage 21D.

When the determination result is Yes in S20, the CPU 21A proceeds to S21 and sets the mode of the vehicle 12 to a predetermined mode while referring to the mode setting information. For example, when the mode setting information of Example 1 is recorded in the storage 21D and the CPU 21A determines that only the driver P1 is present in the vehicle 12 based on the image data acquired by the in-vehicle camera 26, the CPU 21A sets the vehicle 12 to the first mode. Further, for example, when the mode setting information of Example 2 is recorded in the storage 21D and the CPU 21A determines that the fare meter device 20A is calculating the fare, the CPU 21A sets the vehicle 12 to the second mode.

When the determination result is No in S20 or when the process of S21 is ended, the CPU 21A temporarily ends the process of the flowchart shown in FIG. 13.

Next, the process of the flowchart of FIG. 14 will be described.

In S30, the CPU 21A determines whether the vehicle-related information has been acquired.

When the determination result is Yes in S30, the CPU 21A proceeds to S31 and records the acquired vehicle-related information in the storage 21D.

Subsequently, the CPU 21A proceeds to S32 and determines whether a sufficient amount of the vehicle-related information for executing the real-time driving diagnosis is recorded in the storage 21D in the time period between the current time and the time a predetermined time before the current time.

When the determination result is Yes in S32, the CPU 21A proceeds to S33 and executes the real-time driving diagnosis based on the vehicle-related information determined as Yes in S32.

Subsequently, the CPU 21A proceeds to S34 and determines whether the mode of the vehicle 12 is the second mode.

When the determination result is No in S34, the CPU 21A proceeds to S35 and causes the display 28 to display the driving diagnosis result generated in S33 in the first manner over the display time. For example, when the driving diagnosis result related to the accelerator pedal operation is generated in S33, the display 28 displays the image 28A1 in FIG. 6 or the image 28C1 in FIG. 8.

On the other hand, when the determination result is Yes in S34, the CPU 21A proceeds to S36 and causes the display 28 to display the driving diagnosis result generated in S33 in the second manner over the display time. For example, when the driving diagnosis result related to the accelerator pedal operation is generated in S33, the display 28 displays the image 28A2 in FIG. 7 or the image 28C2 in FIG. 9.

When the determination result is No in S30, S32 or when the process of S35, 36 is ended, the CPU 21A temporarily ends the process of the flowchart shown in FIG. 14.

As described above, in the first embodiment, when the vehicle 12 is in the second mode, the display 28 displays the image representing the driving diagnosis result in the second manner that is more difficult to be recognized by the driver P1 and the occupants P2, P3 than in the first manner. That is, the display 28 displays the driving diagnosis result in the second manner, which is difficult for the driver P1 and the occupants P2, P3 to understand and visually recognize. However, the driver P1 understands the meaning of the image representing the driving diagnosis result displayed in the second manner. Therefore, the driver P1 who sees the image representing the driving diagnosis result can know the content of the driving diagnosis result even if the image representing the driving diagnosis result is difficult to visually recognize. On the other hand, it is difficult for the occupants P2, P3 to visually recognize the image representing the driving diagnosis result displayed in the second manner, and they do not understand the meaning of this image. Furthermore, as shown in FIG. 2, since the display 28 is positioned in front of the front seats 16, 17, it is especially difficult for the occupant P3 to visually recognize the image representing the driving diagnosis result displayed in the second manner. Therefore, it is highly unlikely that the content of the driving diagnosis result displayed in the second manner will be known to the occupants P2, P3.

Further, for example, when the mode setting unit 202 sets the vehicle 12 to the first mode based on the mode setting information of Example 1, the driver P1 can clearly visually recognize the driving diagnosis result displayed on the display 28 and can clearly understand the meaning of the driving diagnosis result. Furthermore, in this case, since there are no occupants other than the driver P1 in the vehicle, even if a negative driving diagnosis result is displayed on the display 28, the negative driving diagnosis result will not be known to the occupants other than the driver P1.

Furthermore, in the first embodiment, the external server 30 generates the mode setting information, and the mode of the vehicle 12 is set based on the generated mode setting information. Therefore, the administrator of the external server 30 can set rules for determining the mode of each vehicle 12.

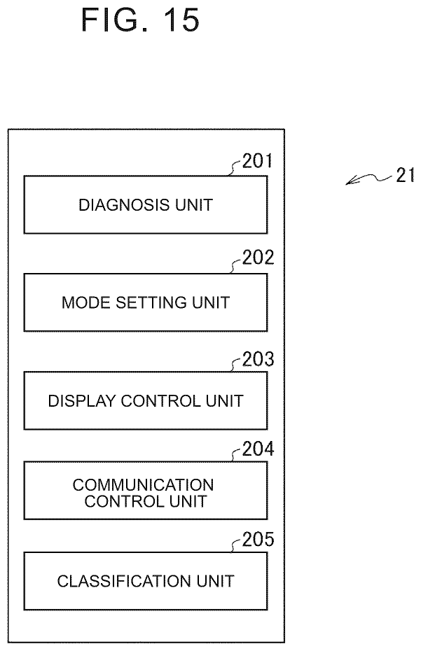

Next, a second embodiment of the present disclosure will be described with reference to FIGS. 15 to 17. The same signs are denoted for configurations similar to that of the first embodiment, and the description thereof is omitted as appropriate.

As shown in FIG. 15, the ECU 21 of the second embodiment has the diagnosis unit 201, the mode setting unit 202, the display control unit 203, the communication control unit 204, and a classification unit 205 as functional configurations.

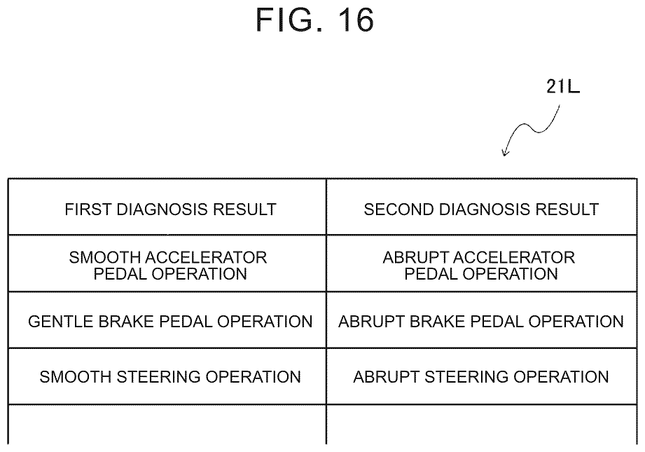

The classification unit 205 classifies the driving diagnosis result generated by the diagnosis unit 201, based on a classification list 21L recorded in the ROM 21B or the storage 21D and shown in FIG. 16. The classification list 21L classifies the driving diagnosis result into two attributes. That is, the classification list 21L defines the first diagnosis result and the second diagnosis result as the attributes of the driving diagnosis result. The first diagnosis result is a positive driving diagnosis result, and the second diagnosis result is a negative driving diagnosis result.

For example, the driving diagnosis result indicating smooth accelerator pedal operation, the driving diagnosis result indicating gentle brake pedal operation, and the driving diagnosis result indicating smooth steering operation belong to the first diagnosis result. For example, the driving diagnosis result indicating abrupt accelerator pedal operation, the driving diagnosis result indicating abrupt brake pedal operation, and the driving diagnosis result indicating abrupt steering operation belong to the second diagnosis result.

The display control unit 203 of the present embodiment determines the display manner of the driving diagnosis result based on the attribute of the driving diagnosis result when the vehicle 12 is in the second mode. That is, when the vehicle 12 is in the second mode, the display 28 displays the image representing the first diagnosis result in the first manner and displays the image representing the second diagnosis result in the second manner.

### Operation and Effects

Next, the operation and effects of the second embodiment will be described.

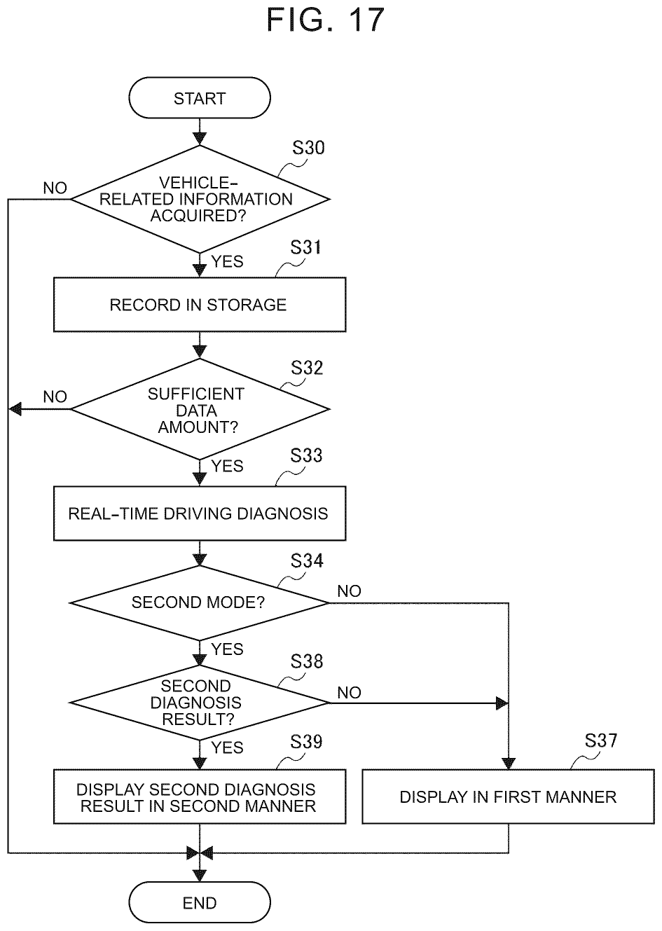

The CPU 21A of the second embodiment repeatedly executes the process of the flowchart shown in FIG. 17 every time a predetermined time elapses. Since S30 to S34 have already been explained, the explanation of these processes will be omitted.

When the determination result is No in S34, the CPU 21A proceeds to S37 and causes the display 28 to display the driving diagnosis result generated in S33 in the first manner over the display time. That is, in this case, the driving diagnosis result is displayed in the first manner on the display 28 regardless of the attribute type of the driving diagnosis result.

On the other hand, when the determination result is Yes in S34, the CPU 21A proceeds to S38 and determines whether the driving diagnosis result generated in S33 is the second diagnosis result.

When the determination result is No in S38, the CPU 21A proceeds to S37. Therefore, the first diagnosis result generated in S33 is displayed on the display 28 in the first manner over the display time.

On the other hand, when the determination result is Yes in S38, the CPU 21A proceeds to S39. In this case, the second diagnosis result generated in S33 is displayed on the display 28 in the second manner over the display time.

When the determination result is No in S30, S32 or when the process of S37, S39 is ended, the CPU 21A temporarily ends the process of the flowchart shown in FIG. 17.

As described above, in the second embodiment, when the vehicle 12 is in the first mode, the driving diagnosis result is displayed on the display 28 in the first manner regardless of whether the driving diagnosis result is the first diagnosis result or the second diagnosis result. Therefore, the driver P1 can clearly visually recognize the driving diagnosis result displayed on the display 28 and can clearly understand the meaning of the driving diagnosis result.

When the vehicle 12 is in the second mode and the diagnosis unit 201 generates the first diagnosis result, the generated first diagnosis result is displayed on the display 28 in the first manner. Therefore, the driver P1 can clearly visually recognize the first diagnosis result displayed on the display 28 and can clearly understand the meaning of the first diagnosis result. In this case, the occupants P2, P3 can also recognize the first diagnosis result by looking at the display 28. However, since the first diagnosis result is a positive driving diagnosis result, there is little possibility that an undesirable situation will occur for the driver P1 when the occupants P2, P3 see the first diagnosis result.

When the vehicle 12 is in the second mode and the diagnosis unit 201 generates the second diagnosis result, the generated second diagnosis result is displayed on the display 28 in the second manner. Therefore, only the driver P1 can know the content of the second diagnosis result that is a negative driving diagnosis result, without the occupants P2, P3 knowing the content of the second diagnosis result.

Although the vehicle display device, the system 10, the vehicle display method, and the program according to each embodiment have been described above, the design of these can be appropriately changed without departing from the scope of the present disclosure.

For example, one of the brightness and saturation of the image displayed on the display 28 in the second manner may be lower than that of the image displayed in the first manner.

The image displayed on the display 28 in the second manner may include characters.

The display 28 may be provided at a position shifted to the left from the center of the instrument panel 20P in the right-left direction. This makes the distance from the front seat 17 to the display 28 longer than the distance from the front seat 16 to the display 28. Therefore, it is more difficult for the occupant P2 to visually recognize the driving diagnosis result displayed in the second manner than for the driver P1. If the right side of the front seat is the driver's seat, it is preferable to shift the position of the display 28 to the right from the center of the instrument panel 20P in the right-left direction.

The external server 30 may have a function corresponding to the diagnosis unit 201 and may perform the driving diagnosis based on the vehicle-related information transmitted from the vehicle 12. In this case, the external server 30 may wirelessly transmit the generated driving diagnosis result to the communication I/F (acquisition unit) 21E of the vehicle 12, and the classification unit 205 may classify the driving diagnosis result received by the vehicle 12.

The external server 30 may have functions corresponding to the diagnosis unit 201 and the classification unit 205. In this case, the external server 30 performs the driving diagnosis based on the vehicle-related information transmitted from the vehicle 12, and classifies the generated driving diagnosis result based on the classification list 21L recorded in the ROM 31B or the storage 31D. The external server 30 wirelessly transmits the generated driving diagnosis result to the vehicle 12 together with the classification information.

The mode setting information may be such that the vehicle 12 is always set to the second mode.

The vehicle 12 does not have to be a taxi.

The content of the classification list 21L may be changeable using a voice input device (not shown) provided on the vehicle 12 or a touch panel provided on the display 28. The external server 30 may wirelessly transmit the input information for the information input device connected to the external server 30 to the vehicle 12, and the ECU 21 may change the content of the classification list 21L based on this input information.

The ECU 21 may generate the mode setting information based on information input using a touch panel provided on the display 28 or a voice input device.

### Appendix

The vehicle display device according to the present disclosure may be any combination of configurations 1 to 6 below.

<Configuration 1> A vehicle display device including: a mode setting unit provided in a vehicle for setting a mode of the vehicle to one of a first mode and a second mode; an acquisition unit provided in the vehicle for acquiring a driving diagnosis result of the vehicle; and a display unit that is able to display an image representing the driving diagnosis result in a first manner when the vehicle is in the first mode, and that is able to display the image representing the driving diagnosis result in a second manner that is more difficult for an occupant of the vehicle to recognize than in the first manner when the vehicle is in the second mode.
<Configuration 2> The vehicle display device in which at least one of brightness and saturation of the image representing the driving diagnosis result in the second manner is lower than the at least one of the brightness and the saturation of the image representing the driving diagnosis result in the first manner.
<Configuration 3> The vehicle display device in which the image representing the driving diagnosis result in the first manner includes a character, and the image representing the driving diagnosis result in the second manner does not include a character.
<Configuration 4> The vehicle display device including a classification unit that classifies the driving diagnosis result into a first diagnosis result or a second diagnosis result based on content of the driving diagnosis result, in which the display unit displays the image representing the second diagnosis result in the second manner when the vehicle is in the second mode and the acquisition unit acquires the second diagnosis result.
<Configuration 5> The vehicle display device in which the display unit is provided on an instrument panel provided in front of a driver's seat of the vehicle.
<Configuration 6> The vehicle display device including an occupant determination unit provided in the vehicle for determining whether there is a general occupant other than a driver in the vehicle based on information from a sensor provided in the vehicle, in which the display unit displays the image representing the driving diagnosis result in the second manner when the occupant determination unit determines that there is the general occupant. Further, the vehicle display system according to the present disclosure may be a combination of configuration 7 below and at least one of configurations 1 to 6.
<Configuration 7> A vehicle display system including the vehicle display device and a driving diagnosis unit that executes driving diagnosis of the vehicle and generates the driving diagnosis result.
Further, the vehicle display method according to the present disclosure may be a combination of configuration 8 below and at least one of configurations 1 to 6.
<Configuration 8> A vehicle display method including: a step of setting a mode of a vehicle to one of a first mode and a second mode; a step of acquiring a driving diagnosis result of the vehicle; and a step of causing a display unit to be able to display an image representing the driving diagnosis result in a first manner when the vehicle is in the first mode, and causing the display unit to be able to display the image representing the driving diagnosis result in a second manner that is more difficult for an occupant of the vehicle to recognize than in the first manner when the vehicle is in the second mode.
Further, the program according to the present disclosure may be a combination of configuration 9 below and at least one of configurations 1 to 6.
<Configuration 9> A program that causes a computer to execute: a process of setting a mode of a vehicle to one of a first mode and a second mode; a process of acquiring a driving diagnosis result of the vehicle; and a process of causing a display unit to be able to display an image representing the driving diagnosis result in a first manner when the vehicle is in the first mode, and causing the display unit to be able to display the image representing the driving diagnosis result in a second manner that is more difficult for an occupant of the vehicle to recognize than in the first manner when the vehicle is in the second mode.

What is claimed is:

1. A vehicle display device comprising:
a mode setting unit provided in a vehicle for setting a mode of the vehicle to one of a first mode and a second mode;
an acquisition unit provided in the vehicle for acquiring a driving diagnosis result of the vehicle;
a display unit that is able to display an image representing the driving diagnosis result in a first manner when the vehicle is in the first mode, and that is able to display the image representing the driving diagnosis result in a second manner that is more difficult for an occupant of the vehicle to recognize than in the first manner when the vehicle is in the second mode.

2. The vehicle display device according to claim 1, wherein at least one of brightness and saturation of the image representing the driving diagnosis result in the second manner is lower than the at least one of the brightness and the saturation of the image representing the driving diagnosis result in the first manner.

3. The vehicle display device according to claim 1, wherein the image representing the driving diagnosis result in the first manner includes a character, and the image representing the driving diagnosis result in the second manner does not include a character.

4. The vehicle display device according to claim 1, further comprising a classification unit that classifies the driving diagnosis result into a first diagnosis result or a second diagnosis result based on content of the driving diagnosis result, wherein the display unit displays the image representing the second diagnosis result in the second manner when the vehicle is in the second mode and the acquisition unit acquires the second diagnosis result.

5. The vehicle display device according to claim 1, wherein the display unit is provided on an instrument panel provided in front of a driver's seat of the vehicle.

6. The vehicle display device according to claim 1, further comprising an occupant determination unit provided in the vehicle for determining whether there is a general occupant other than a driver in the vehicle based on information from a sensor provided in the vehicle, wherein the mode setting unit sets the vehicle to the second mode when the occupant determination unit determines that there is the general occupant.

7. A vehicle display system comprising:
the vehicle display device according to claim 1; and
a driving diagnosis unit that executes driving diagnosis of the vehicle and generates the driving diagnosis result.

8. A vehicle display method comprising:
a step of setting a mode of a vehicle to one of a first mode and a second mode;
a step of acquiring a driving diagnosis result of the vehicle; and
a step of causing a display unit to be able to display an image representing the driving diagnosis result in a first manner when the vehicle is in the first mode, and causing the display unit to be able to display the image representing the driving diagnosis result in a second manner that is more difficult for an occupant of the vehicle to recognize than in the first manner when the vehicle is in the second mode.
